(19) United States
(12) Patent Application Publication
(10) Pub. No.: US 2003/0168872 A1
(43) Pub. Date: Sep. 11, 2003

(54) Grappler with horizontal contact shoe

(76) Inventors: Daniel Brian Zakula SR., Mokena, IL (US); Daniel J. Olson, Orland Park, IL (US)

Correspondence Address: PATENT DOCKET DEPARTMENT, GARDNER CARTON & DOUGLAS LLC, 191 N. WACKER DRIVE, SUITE 3700, CHICAGO, IL, 60606, US

(21) Appl. No.: 10/093,183

(22) Filed: Mar. 6, 2002

(51) Int. Cl. B66C 1/66

(52) U.S. Cl. 294/81.51

(57) ABSTRACT

A swing arm style grappler for a gantry crane is equipped with contact shoes configured to engage in horizontal, flush contact at the underside of a standard load. The grappler includes a plurality of pivotable arms movable between an unclamped position, wherein the arms are positioned outwardly free from the load, and a clamped position wherein the arms are positioned inwardly to clamp the load. Each of the arms has an elongate portion, one of the shoes being mounted to a lower end of the elongate portion. The shoe includes a lifting shelf which projects generally inwardly at an angle such that, when the arms are in the clamped position, the shelf is horizontal.

### FIELD OF THE INVENTION

This invention relates to grapplers for gantry cranes, and more particularly to contact shoes for a swing-arm grappler.

### BACKGROUND OF THE INVENTION

Gantry cranes are commonly used in ports, rail yards or other intermodal shipping facilities for lifting and moving large containers, such as truck trailers. Such cranes are equipped with various types of grappler mechanisms to accommodate certain container configurations and associated standard latching systems. For example, highway trailers are typically lifted using a grappler having a swing-arm mechanism, and a standard shipping container typically has four twistlock latches located at the upper four corners of the container requiring a twistlock grappler mechanism. Some grapplers are equipped with both swing arms and twistlocks for selective use as appropriate.

A conventional swing arm grappler includes a platform which is suspended from vertically movable stabilizer beams or another suitable vertically movable mechanism of the gantry crane. The grappler typically includes two pairs of swing-arms pivotally mounted to the base for movement between an unclamped position in which the arms are outwardly pivoted, free of the trailer, and a clamped position in which the arms are pivoted inwardly to clamp the trailer. The crane is typically equipped with a hydraulic actuation system adapted to move the swing arms between the clamped and unclamped positions.

In the clamped position, the pivot arms generally extend downwardly from the platform along the sides of the trailer. Each of the arms includes a contact shoe which extends perpendicularly inwardly to reach under and engage a structural member of the trailer for lifting. More particularly, each of the arms has an elongate body, an upper end of the elongate body being pivotally mounted to the grappler platform, and a lower end to which the shoe is mounted.

The conventional shoe has a lifting shelf which extends at a right angle from the elongate portion of the arms so that the lifting shelf is horizontal when the respective arm is vertical. However, when the arms of the conventional grappler are vertically oriented, the arms are not clamped against a standard trailer. Rather, when the arms are in a vertical orientation the conventional grappler is free of the trailer, the arms being in an open position. Accordingly, when the arms of the conventional grappler are moved inwardly to the clamped position, the lifting shelf of the contact shoe is at a non-horizontal orientation, extending at an upward angle. As a result, the shoe contacts the structural member of the trailer at an angle in a non-flush manner.

Unfortunately, non-horizontal, non-flush seating of the contact shoes against the underside of the trailer leads to various problems. If the shoe engages the trailer at a non-flush, angular orientation, the contact between the shoe and trailer is limited to a line or point. The resulting increased load concentration can damage the trailer, causing plastic deformation, dents, punctures and/or cuts in the lifting surface. Moreover, a non-flush contact can result in slipping between the shoe and the lifting surface, possibly causing the trailer to slip off of the shoe. In view of the foregoing, a need exists for an improved shoe of a grappler arm.

### SUMMARY OF THE INVENTION

The present invention overcomes problems associated with conventional grapplers. In an exemplary embodiment, a grappler according to teachings of the invention includes a suspended platform and a plurality of arms pivotably mounted thereto. The arms have left arms and right arms movable relative to each other between an open position in which the left arms and right arms are disposed on respectively opposite sides of a standard load with clearance and a clamped position in which the respective left and right arms are moved inwardly toward each other to clamp against the load. Each of the arms has an elongate body with an upper end mounted to the platform and an opposite lower end. Each of the arms further has a shoe with a lifting shelf to support a bottom surface of the load when the arms are in the clamped position. The lifting shelf extends generally inwardly from the lower end of the elongate body at an angle such that the lifting shelf is generally horizontal when the respective arm is in the clamped position.

In an embodiment, the lifting shelf extends at an angle of greater than 90 degrees relative to the elongate body. In a particular embodiment, the shoe extends from the elongate body at an angle of about 95 degrees.

In an embodiment, when the arms are in a generally vertical orientation, the arms are clear of the load, in the open position.

Preferably, the grappler is sized and dimensioned to accommodate a load which is a trailer having a standard width. In a particular embodiment, the load has a width of about 102 inches. In a related embodiment, the shoes of the respective left arms and the right arms are separated by a distance of about 124 inches when the respective elongate portions of the arms are vertically oriented. When the grappler arms are in an open position clear of the load, and wherein the elongate portions of the arms are generally vertical, the average clearance between each of the shoes and the load is preferably about 11 inches.

An advantage of the present invention is that it provides an improved grappler shoe.

Another advantage of the present invention is that it provides grappler shoes which improve stability of a load supported on the shoes.

A further advantage of the present invention is that it provides a grappler shoe that has an orientation which is as close as possible to horizontal when supporting a load.

Yet another advantage of the present invention is that it provides a grappler shoe which has improved grip on a load.

Additional features and advantages of the present invention are described in, and will be apparent from, the following description, claims and figures.

### BRIEF DESCRIPTION OF THE DRAWINGS

FIG. 1 is a perspective view of a gantry crane having a swing-arm style grappler, the crane having features in accordance with teachings of the invention.

FIG. 2 is a side elevation of the gantry crane of FIG. 1, the grappler positioned generally over a trailer to be lifted.

FIG. 3 is a rear elevation of the gantry crane of FIGS. 1 and 2.

FIG. 4a is a front elevation of the grappler of the gantry crane of FIG. 1, the grappler having arms which are in an unclamped position free from the trailer.

FIG. 4b is a front elevation of the grappler, the arms in a clamped position and the grappler being elevated to lift the trailer from the ground.

FIG. 5 is a fragmentary view of the grappler showing an upper end of the arm being pivotally mounted to the grappler platform, and an hydraulic actuator for moving the arm between clamped and unclamped positions.

FIG. 6 is a fragmentary elevation of a lower portion of an arm having a shoe according to teachings of the present invention, the angle of the shelf disposed at an angle β relative to the arm suitable to yield a horizontal contact against the object to be lifted.

FIG. 7 is a fragmentary perspective view of the arm of FIG. 6.

FIG. 8 is a fragmentary elevation of a lower portion of an arm having a conventional shoe, the shelf disposed at right angle relative to the elongate body of the arm.

FIG. 9 is a fragmentary perspective view of the conventional shoe of FIG. 8.

FIG. 10a is a fragmentary rear elevation of an arm with the conventional shoe of FIGS. 8 and 9 in a clamped position against a trailer, the shelf of the conventional shoe engaging the underside of the trailer at a non-horizontal orientation.

FIG. 10b is a fragmentary rear elevation of an arm with the shoe of FIGS. 6 and 7 in a clamped position against a trailer, the shelf of the shoe flushly engaging the underside of the trailer at a horizontal orientation.

### DETAILED DESCRIPTION OF THE PRESENTLY PREFERRED EMBODIMENTS

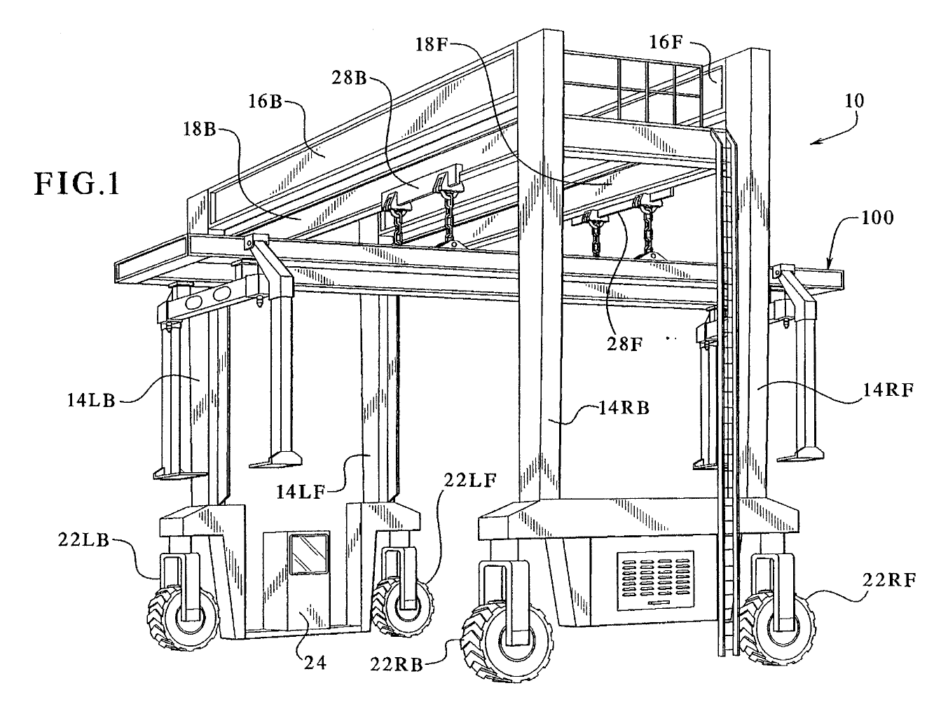

Now turning to the drawings, wherein like numeral designate like components, FIGS. 1, 2 and 3 illustrate an exemplary gantry crane 10 having a swing-arm style grappler 100 configured for lifting a standard load, such as a trailer. Gantry cranes are generally known, and although it is not required for practicing the invention, basic elements of the exemplary gantry crane 10 will be generally described before the inventive features will be described in detail.

As shown in FIG. 1, the gantry crane 10 includes a frame structure having four generally vertical columns 14RF, 14LF, 14RB, 14LB, a front support beam 16F rigidly mounted to extend generally horizontally between columns 14RF and 14LF, and a rear support beam 16B rigidly mounted to extend generally horizontally between columns 14RB and 14LB.

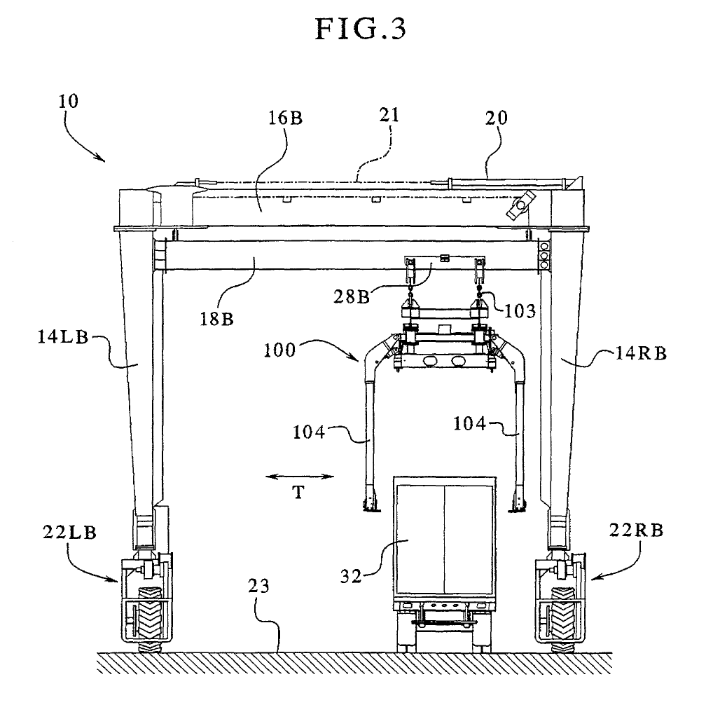

For vertical lifting capability, the crane 10 further includes a lifting means for vertically moving the grappler. Various lifting means will be recognized by those skilled in the art. For example, in the embodiment generally illustrated in FIGS. 1, 2 and 3, the lifting means includes vertically movable front and rear stabilizer beams 18F and 18B, respectively. The stabilizer beams 18F and 18B are movably mounted to extend generally horizontally between columns 14RF and 14LF and columns 14RB and 14LB, respectively. Various mechanisms may be used to actuate the vertical lifting of the stabilizer beams 18F, 18B. For example, as illustrated in FIG. 3, crane 10 includes a piston and cylinder type hydraulic actuator 20 connected to a cable or chain 21 that suspends the stabilizer beams 18B. By extending or retracting the piston of the hydraulic actuator 20, the cable 21 is moved to lower or raise the respective stabilizer beam 18B. A similar actuator and cable (not shown) are operable to move the other stabilizer beam 18F (FIG. 1). In another example, the lifting means can include a hoist system having movable wire ropes from which the grappler is suspended from overhead trolleys mounted to fixed upper beams of the crane. In an alternative structure, the stabilizer beams are suspended from wire ropes that are fed and retracted from a rotatable drum that is driven by, for example, a hydraulic motor.

Although stationary cranes are known, cranes are typically mobile units adapted for maneuvering on a pavement. For example, as illustrated in FIG. 1, the crane 10 is equipped with a plurality of wheel assemblies 22RF, 22LF, 22RB, 22LB which support the columns 14RF, 14LF, 14RB, 14LB. The wheel assemblies are actuatable to drive, steer and maneuver the crane 10 on a pavement surface 23 in a desired manner.

To drive its various components, the crane 10 typically includes a hydraulic system which includes a plurality of hydraulic actuators to drive the various components. For example, hydrostatic motors are commonly used to drive the stabilizer beam lifting mechanism and to drive the wheels, and hydraulic pistons are commonly used for steering the wheel assemblies 22RF, 22LF, 22RB, 22LB, and operate various other crane functions, such as for moving elements of the grappler 100.

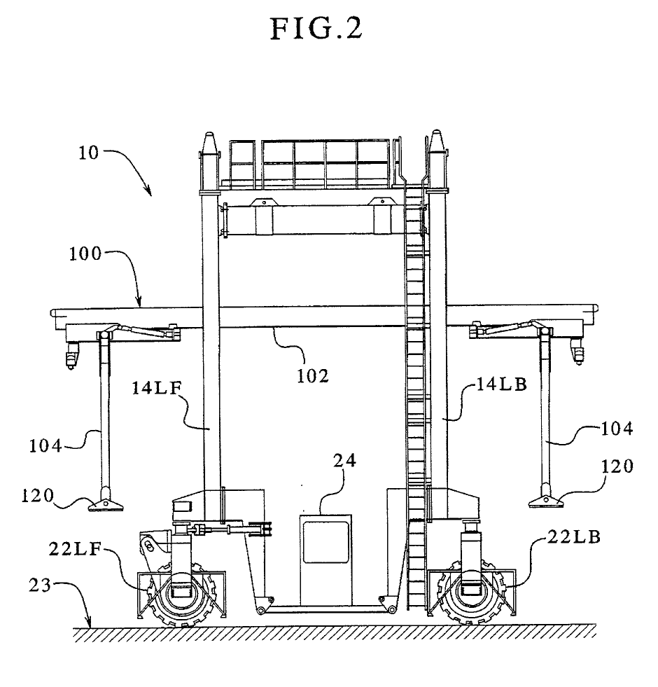

Referring to FIGS. 1 and 2, the crane 10 includes a cab 24 mounted to the frame 12 for accommodating an operator. The cab 24 contains controls for steering, driving, and maneuvering the crane 10 and for manipulating the motion and functions of the grappler 100. The crane 10 also includes a power unit, typically having an internal combustion engine driving a hydraulic pump.

To prepare for lifting a container, the operator maneuvers the crane 10 generally in position to straddle an object to be lifted by the grappler 100, such as illustrated. The operator then adjusts the grappler 100 to a more precise position ready to grip the object. More particularly, the grappler 100 is vertically movable by raising or lowering the stabilizer beams 18F and 18B (FIG. 1). For moving the grappler 100 in a side-to-side or transverse direction, as indicated by the axis T (FIG. 3), the grappler 100 is mounted to front and rear trolleys 28F and 28B, and each of the trolleys 28F, 28B is mounted to a respective one of the stabilizer beams 18F and 18R. Each of the trolleys 28F, 28B includes a plurality of rollers which roll along a surface of the respective stabilizer beam 18F, 18B. Each of the trolleys is driven by an appropriate mechanism, for example, by cables actuated by a hydraulic piston.

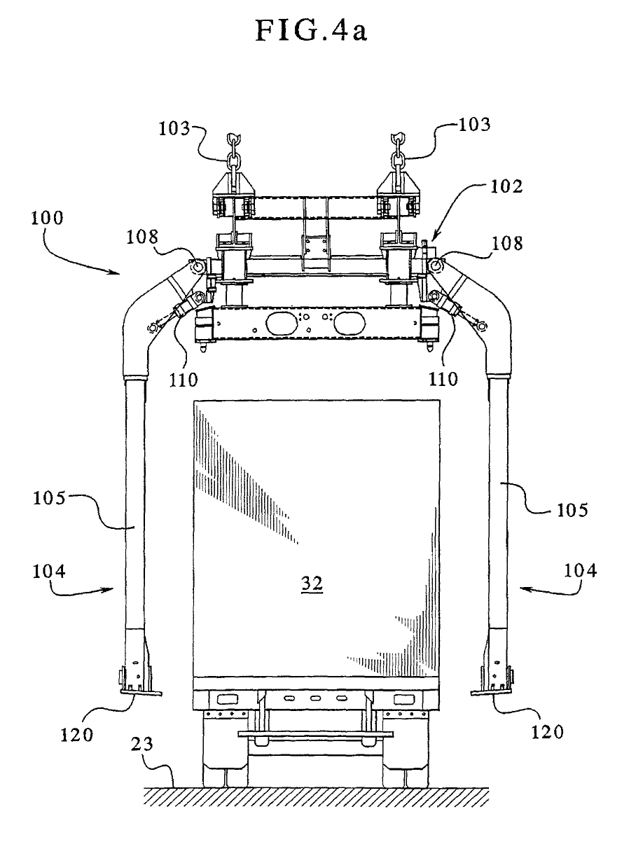

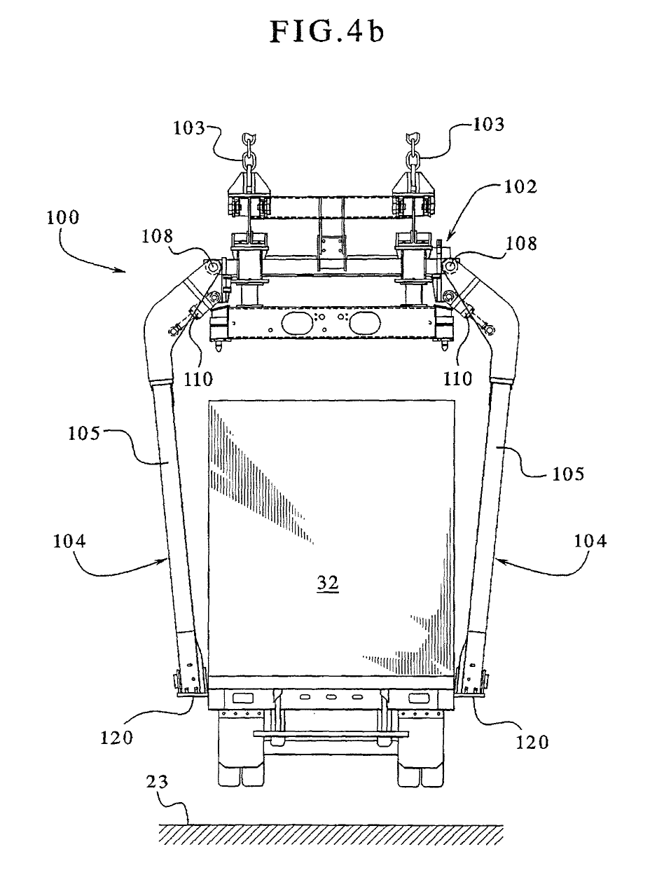

The grappler 100 is adapted to engage, lift and handle loads, such as a trailer 32, as illustrated in FIGS. 3, 4a and 4b. The grappler 100 generally includes a platform 102 and two pairs of arms 104. The platform 102 is suspended from the trolleys 28F, 28B (FIGS. 1 and 3) by chains 103 or some other appropriate structure. Each of the arms 104 includes an elongate body 105 and a contact shoe 120 mounted to a lower end of the elongate body 105. The contact shoe 120 extends generally inwardly to reach under a holding surface, such as a structural frame member of the trailer for lifting.

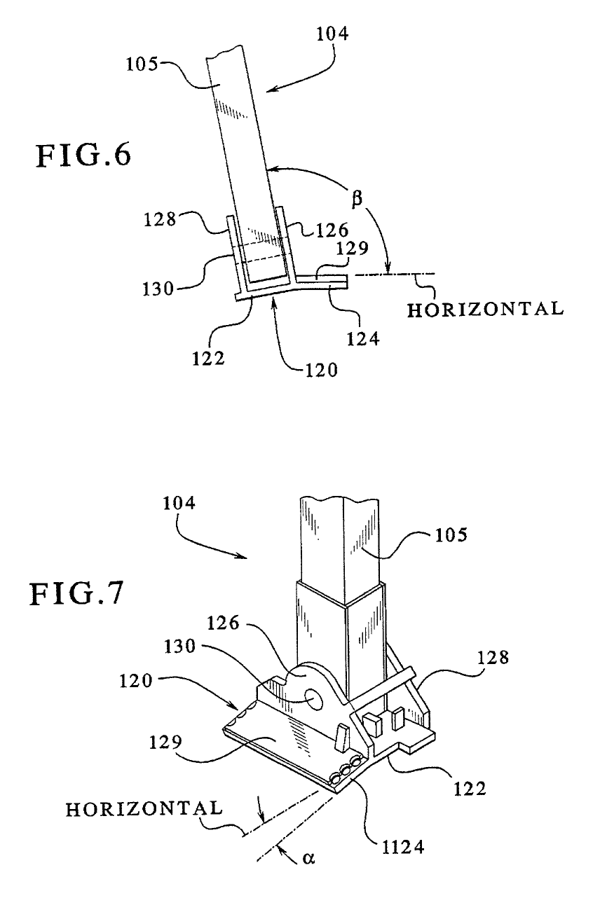

An embodiment of the shoe 120 is illustrated in greater detail in FIGS. 6 and 7. The shoe 120 generally includes a mounting portion 122 which is mounted to the lower end of the elongate body 105 of the arm 104 and a cantilevered lifting shelf 124 which extends from the mounting portion 122. As illustrated in FIG. 6 and 7, the mounting portion 122 of the contact shoe 120 includes first and second bracket members 126 and 128. A pin 130 is disposed through the bracket members 126, 128, as shown in FIG. 6, for securing the shoe 120 to the elongate body 105 of the arm 104. The shelf 124 may be equipped with an upwardly facing resilient pad 129 to enhance frictional grip against a load. Additional features of the shoe 120 are described below.

Turning now to FIGS. 4a and 4b, each of the arms 104 is pivotably mounted to the platform 102 at a hinge 108, and is movable about a respective rotational axis. In particular, each of the arms 104 is movable between an open position, as illustrated in FIG. 4a, and a closed or clamped position, as illustrated in FIG. 4b. When the arms 104 are in the open position (FIG. 4a), the grappler 100 is free from the trailer 32 for positioning movement, and when the arms 104 are in the closed position (FIG. 4b), the grappler 100 is ready to lift the trailer 32.

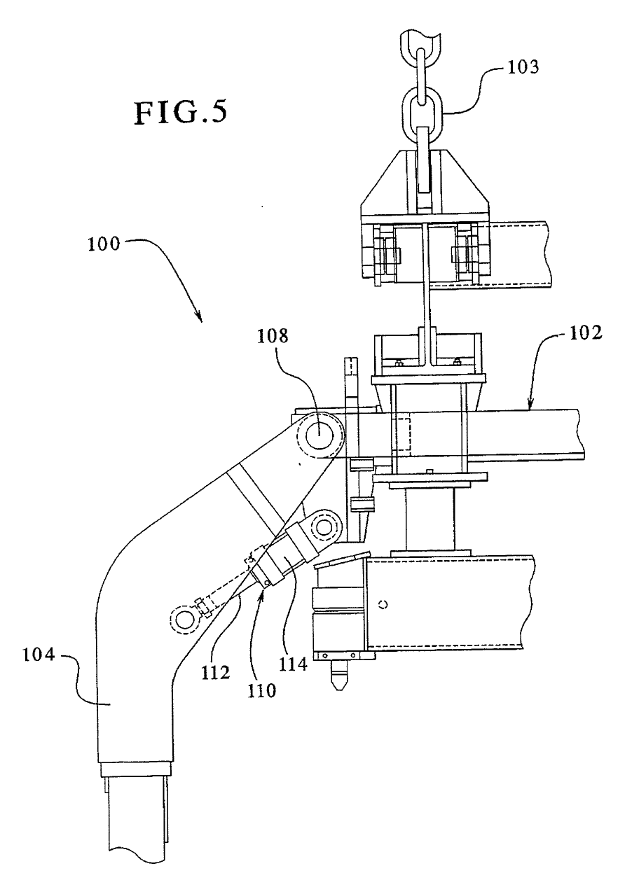

To move the arms, the crane 10 includes a plurality of hydraulic actuators 110, wherein each of the actuators is operable to drive an associated one of the arms 104. In the example shown in FIGS. 1-5, each of the actuators 110 is a piston-cylinder assembly. More specifically, referring to FIG. 5, the actuator 110 is illustrated in greater detail to include a respective piston 112 and associated cylinder 114. In the grappler 100 illustrated in FIGS. 15, the actuators 110 are extended to move the respective arms 104 outwardly, and the actuators 110L, 110R are retracted to move the arms 104 inwardly.

Each of the arms 104 is sized to extend downwardly alongside the trailer 32 so that the shoes 120 are positionable under a frame of the trailer 32. As a result, the shoes 120 contact upwardly against the trailer 32 for lifting the trailer as the grappler 100 is raised, as shown in FIG. 4b.

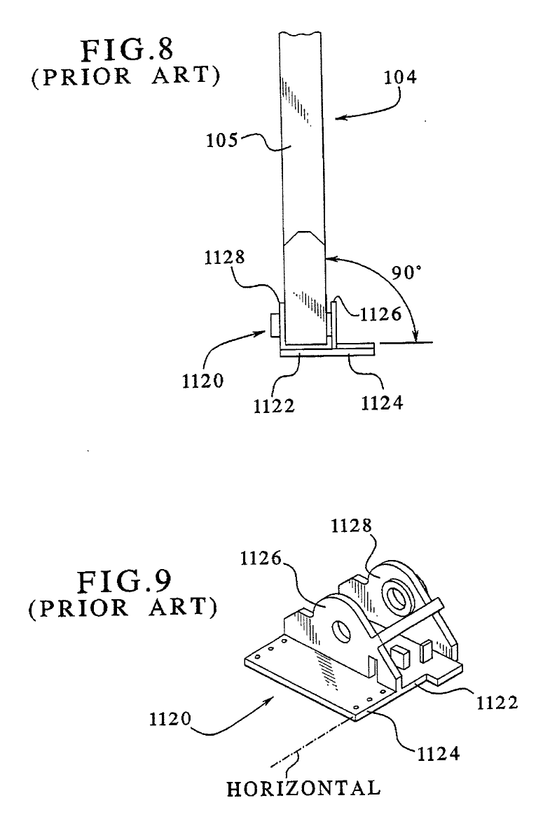

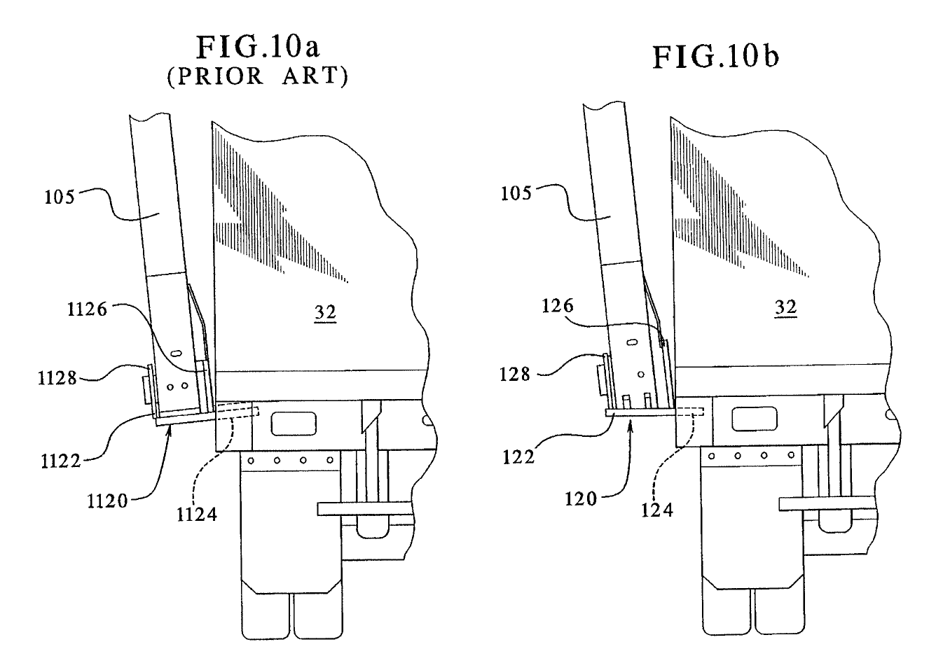

A conventional shoe 1120, as illustrated in FIGS. 8 and 9, has been problematic. The conventional shoe 1120 generally includes a mounting portion 1122 and a cantilevered lifting shelf 1124 which extends from the mounting portion 1122 to be disposed at a right angle relative to the elongate body 105 of the arm 104. In order to lift a trailer with the conventional shoe 1120, the arm 104 must be pivoted inwardly to the clamped position so that the shoe 1120 meets a side of the load, as illustrated in FIG. 10a. However, when in the clamped position as shown in FIG. 10a, the elongate body 105 of the respective arm 104 is not vertical, and as a result, the conventional right-angled shoe 1120 is not horizontal. Thus, the conventional shoe 1120 does not seat in a flush manner against the frame rail of the trailer 32; rather, only a distal edge of the conventional shoe 1120 contacts the rail with a line contact. The non-flush contact places a high force in a small area which can damage the trailer. Additionally, the conventional shoe 1120 can slip from the trailer due to the non-flush contact.

In accordance with an aspect of the invention, each of the grappler arms has a shoe which extends inwardly at an angle selected such that the upwardly facing surface of the shoe is in a generally horizontal orientation when the arms are at a position for engaging a standard sized object which has a predetermined width. In a particular embodiment, the shoes are disposed at an angle relative to the arm so the shoe meets flushly against an underside of a frame rail of a trailer adapted for highway use.

Turning to FIG. 6, the lifting shelf 124 extends from the mounting portion 122 of the shoe 120 so that the lifting shelf 124 is disposed at an angle β relative to the elongate body 105. The angle β is greater than 90 degrees. As a result, when the elongate body of the arm is vertically oriented, the lifting shelf 124 extends downwardly at an angle α relative to horizontal, as illustrated in FIG. 7. (β equals α plus 90 degrees). The angle β is selected such that the lifting shelf 124 is generally horizontal when the arm is in the clamped position, as shown in FIGS. 4b and 10b, wherein an inwardly facing surface of the bracket member 126 meets the side of the trailer 32. This orientation results in a flush contact of the shoe 120 against the underside frame rail of the trailer 32.

Advantageously, because the lifting shelf 124 is at a horizontal orientation when the arms 104 are in the clamped position, the present invention provides improved stability of grip when the grappler 100 is lifting a load. Additionally, the shoe 120 is less likely to damage a load because it can engage the underside of the load in a flush manner.

In order to further improve the lifting stability of the shoe 120, the shoe 120 is preferably dimensioned differently relative to a conventional shoe 1120 (FIGS. 6, 7, 10a). For example, as can be seen from a comparison of FIGS. 10a and 10b, lifting shelf 124 of the shoe 120 has a dimension in an inward direction (toward the load) which is shorter than that of the conventional shoe 1120. It has been found that the shoe 120 is less likely to inflict damage to the load when sized to have such a shorter dimension. Additionally, the edges of the projecting shelf 124 are rounded to avoid cutting the tires of the trailer. Moreover, the shoe 120 has a longer dimension in a longitudinal direction relative to the trailer 32, in comparison to the conventional shoe 1120, as this has also been found to improved stability and grip.

Those skilled in the art will recognize that the grappler 100 may be used for lifting a variety of types of objects or containers, particularly objects having a lower surface or recess which can receive the shoes. Accordingly, the term “trailer” as used herein shall not be construed to limit the scope of the invention and includes any load, object or container capable of being lifted by the arms of the grappler.

Those of skill in the art will recognize that the β and α may vary among different grappler embodiments. For example, the necessary angles β and α will depend upon the geometry and dimensioning of the particular grappler arms, the width of the particular standard load, the width between the pivot points of the arms relative to the platform. Within the scope of the invention, a shoe can be appropriately designed to account for such various dimensional specifications so that the shelf is in horizontal, flush contact against the load when the arms are in a clamped position. For example, in a specific exemplary embodiment, to accommodate a standard sized highway trailer having a width of about 102 inches, each of the arms 104 has a dimension of about 165 in. from the pivot 108 to the shoe 120. In such an embodiment, the angle β is preferably about 95 degrees.

The arms 104 are made of steel or some other high tensile strength material to support heavily loaded trailers, which frequently weigh about 40,000 to 120,000 pounds. It will be understood that the crane 10 may be configured to handle loads which weigh less or more. Many highway trailers weigh less due to vehicle weight restrictions, but depending on the intended use of the crane, the crane could be designed for lifting trailers or containers which weigh significantly more.

While the invention is described herein in connection with certain preferred embodiments, the invention is not limited it to those embodiments. On the contrary, it is recognized that various changes and modifications to the described embodiments will be apparent to those skilled in the art, and that such changes and modifications may be made without departing from the spirit and scope of the present invention. Accordingly, the intent is to cover all alternatives, modifications, and equivalents included within the spirit and scope of the invention as defined by the appended claims.

What is claimed is:

1. A grappler for a gantry crane, the grappler comprising:
a suspended platform; and
a plurality of arms pivotably mounted to the platform, the arms including left arms and right arms being movable relative to each other between an open position in which the left arms and right arms are disposed on respectively opposite sides of a standard load with clearance and a clamped position in which the respective left and right arms are moved inwardly toward each other to clamp the load; each of the arms including:
an elongate body having an upper end mounted to the platform and an opposite lower end; and
a shoe mounted to the elongate body, the shoe having a lifting shelf to support a bottom surface of the load when the arms are in the clamped position, the lifting shelf extending generally inwardly from the lower end of the elongate body at an angle such that the lifting shelf is generally horizontal when the respective arm is in the clamped position.

2. The grappler of claim 1, wherein the shelf is disposed at an angle of greater than 90 degrees relative to the elongate body.

3. The grappler of claim 1, wherein the shelf is disposed at an angle of about 95 degrees relative to the elongate body.

4. The grappler of claim 1, wherein each of the arms is clear of the standard load when the respective elongate portion is disposed at a generally vertical orientation.

5. The grappler of claim 1, wherein the grappler is dimensioned such that the shoes of the respective left arms and the right arms are separated by a distance of about 124 inches when the respective elongate portions of the arms are vertically oriented.

6. The grappler of claim 1, wherein the standard load has a width of about 102 inches, and wherein the grappler is dimensioned such that the average clearance between each of the shoes and the load is about 11 inches.

7. The crane of claim 1, wherein the standard-sized object is a trailer configured for highway travel.

8. The grappler of claim 1, wherein each of the arms is disposed at a non-vertical orientation when the arms are in the clamped position against the standard load.
